(19) United States
(12) Patent Application Publication
(10) Pub. No.: US 2025/0145427 A1
(43) Pub. Date: May 8, 2025

(54) TELESCOPIC BOOM FOR A WORKING DEVICE, IN PARTICULAR A CRANE OR MOBILE CRANE

(71) Applicant: Palfinger AG, Bergheim bei Salzburg (AT)

(72) Inventor: Christoph ROECK, Bad Hofgastein (AT)

(21) Appl. No.: 19/013,559

(22) Filed: Jan. 8, 2025

Related U.S. Application Data
(63) Continuation of application No. PCT/AT2023/060239, filed on Jul. 17, 2023.

(30) Foreign Application Priority Data
Jul. 20, 2022 (AT) GM 50115/2022

(51) Int. Cl. B66C 23/70

(52) U.S. Cl. CPC B66C 23/707; B66C 23/703; B66C 23/705

(57) ABSTRACT

A telescopic boom for a working device, in particular a crane or mobile crane, includes at least three telescopic sections. A first telescopic section is arranged at least partially around a second telescopic section, and the second telescopic section is arranged at least partially around a third telescopic section. A drive device is provided for telescopically retracting and/or extending the second telescopic section relative to the first telescopic section, and a synchronizing device is configured to allow the third telescopic section to be telescopable relative to the second telescopic section, in particular synchronously. The synchronizing device is arranged substantially completely within the second telescopic section.

The present application is a continuation of International Application PCT/AT2023/060239 filed on Jul. 17, 2023. Thus, all of the subject matter of International Application PCT/AT2023/060239 is incorporated herein by reference.

### BACKGROUND OF THE INVENTION

The invention relates to a telescopic boom for a working device, in particular a crane or mobile crane, comprising at least three telescopic sections, wherein a first telescopic section is arranged at least in certain regions around a second telescopic section and the second telescopic section is arranged at least in certain regions around a third telescopic section, at least one drive device for telescopically retracting and/or extending the second telescopic section relative to the first telescopic section and at least one synchronizing device by means of which the third telescopic section is telescopable relative to the second telescopic section, in particular synchronously. Furthermore, the invention relates to a working device, in particular a crane or mobile crane, with at least one such telescopic boom. Furthermore, the invention relates to a method for telescopically retracting or extending such a telescopic boom.

A telescopic boom with telescopic sections is already known from document WO 2014/006474 A1.

A disadvantage of the current technology is that the weight of the hydraulic systems for the telescoping movements is high and hydraulic controls are maintenance-intensive. Furthermore, the innermost telescopic section is generally designed to accommodate extensions and/or load-carrying devices, so that adaptation options of the known hydraulic systems are limited. In hydraulic systems, loads are unfavorable for efficient use of the work equipment—particularly due to a center of gravity distribution and/or empty weights in the telescopic section—wherein a hydraulic system arranged within the innermost telescopic section is not an option for reasons of space and technical feasibility.

### SUMMARY OF THE INVENTION

The objective technical problem of the present invention is therefore to provide a telescopic boom which is improved compared to the prior art, in which the disadvantages of the prior art are at least partially eliminated, and which is characterized in particular by an efficient use of space in the telescopic sections and/or an efficient weight distribution with a small number of components and/or as being low-maintenance.

According to the invention, the at least one synchronizing device is arranged substantially completely within the second telescopic section.

This makes it possible that the storage space within the third telescopic section-generally the innermost telescopic section—can be used to accommodate the synchronizing device. A particularly compact telescopic boom can therefore be provided.

Arrangement of the at least one synchronizing device substantially completely within the second telescopic section is provided at least in one operating position. Particularly preferably, this arrangement is present both in a telescopically retracted operating position and in a telescopically extended operating position of the second telescopic section and/or the third telescopic section.

In addition, there is the positive property that, with existing hydraulic control of the telescopic sections or telescopic extension arms, an increase in range can be achieved by an additional telescopic section—the third telescopic section-without having to rely on additional external extensions on the telescopic section.

Particularly preferably, the synchronizing device itself is not controlled (hydraulically, electrically or the like), but can generate a mechanical coupling of the third telescopic section with the second telescopic section via the first telescopic section, such that a telescopic movement of the second telescopic section out of the first telescopic section automatically causes a telescopic movement of the third telescopic section out of the second telescopic section. Synchronous chains or sequential controls are arranged at least partially outside the telescopic sections—at least outside the second telescopic section.

Furthermore, the synchronizing device can be designed such that a telescoping movement of the third telescopic section can be deactivated. A particularly favorable center of gravity distribution can be generated in that at least one synchronizing device is arranged completely within the telescopic sections, wherein the at least one synchronizing device is protected from contamination and/or weather. A mechanical synchronizing device is considerably lighter than hydraulic systems and/or electrical controls, wherein the inherent moment on the telescopic boom increases only minimally due to the internal arrangement and in particular due to the arrangement within the penultimate telescopic section—the second telescopic section.

Furthermore, the increase in range generated by the at least one synchronizing device can be flexibly implemented or retrofitted to a plurality of different telescopic booms and/or working devices such as cranes, hoists, or the like. Due to the defined range increase, comfort functions such as overload monitoring and/or range measurement can be adjusted according to the at least one synchronizing device.

The first telescopic section can itself be telescopable, but this is generally not necessary. In the retracted operating position of the telescopic boom, the first telescopic section encloses the two other telescopic sections at least in certain regions, wherein the third telescopic section is arranged within planes which are spanned by side surfaces of the second telescopic section. A telescopic boom can be considered synonymously as a telescopic boom or telescoping boom.

In this context, telescopic section can be used synonymously with the term telescopic boom. Preferably, the at least one synchronizing device conveys a synchronous movement of the innermost or third telescopic boom, wherein in general an asynchronous movement can be generated via the at least one synchronizing device, for example by translation means.

As stated at the outset, protection is also sought for a working device, in particular a crane or mobile crane, with at least one such telescopic boom, wherein in particular at least one other telescopic section is provided, which is arranged at least in certain regions around the at least three telescopic sections.

This allows for a working device which has an additional telescopic section—in particular one which is not externally and/or hydraulically controlled—or, if the number of telescopic sections is the same, which efficiently uses the last telescopic section for simultaneous telescoping with the penultimate telescopic section.

As stated at the outset, protection is also sought for a method for telescopically retracting or extending such a telescopic boom, wherein the following method steps are carried out, in particular in parallel: the second telescopic section is moved translationally relative to the first telescopic section via the, in particular hydraulic, drive device, and the third telescopic section is moved translationally relative to the second telescopic section by a movement of the second telescopic section via the at least one synchronizing device, preferably synchronously.

According to an advantageous embodiment of the invention, the first telescopic section is designed to be telescopic or non-telescopic relative to at least one other telescopic section via at least one other drive device.

The number of telescopic sections of the telescopic boom is generally arbitrary. The first telescopic section can therefore represent the telescopic section closest to a crane base, which is not itself telescopic, or can itself be designed to be telescopable relative to other telescopic sections. The third-innermost-telescopic section is automatically moved via the at least one, preferably mechanical, synchronizing device by a telescoping movement of the second telescopic section relative to the first telescopic section.

Advantageously, the at least one synchronizing device is arranged at least in certain regions within the third telescopic section and completely within planes spanned by at least four, preferably all, side surfaces of the third telescopic section.

Preferably, the at least one synchronizing device is arranged completely within the second—penultimate—telescopic section, preferably in the course of a complete telescoping movement, and is moved at least partially into the first telescopic section in the course of the retracting telescoping movement and/or at least partially out of the third telescopic section in the course of an extending telescoping movement.

It has proven advantageous that the at least one synchronizing device is designed in the form of a chain, a belt, and/or a rope, wherein preferably the chain, the belt, and/or the rope is elastically deformable.

Particularly preferably, the synchronizing device is in the form of a chain which is arranged, preferably directly via fastening means, on the second telescopic section and/or on the third telescopic section.

According to an alternative embodiment of the invention, the at least one synchronizing device is designed as a rack with a gear, wherein preferably the gear is arranged on the second telescopic section, preferably on a rear wall of the second telescopic section, and located within the second telescopic section, at least in certain regions, protruding into the third telescopic section, and/or the rack is arranged at least in certain regions, particularly preferably completely, within the third telescopic section.

It has proven advantageous that the at least one synchronizing device comprises at least one deflection roller. The at least one synchronizing device is guided around the at least one deflection roller and/or is connected to itself, and preferably at least two deflection rollers spatially separated from one another are provided.

A translational movement of the second telescopic section is transmitted to the third telescopic section via the at least one synchronizing device by the at least one deflection roller, wherein the at least one deflection roller is preferably arranged within the first and/or second and/or third telescopic section—preferably in all operating positions arranged within the second telescopic section.

An advantageous variant consists in that the second telescopic section comprises at least one fastening device, preferably a profile or profile tube which is arranged directly or indirectly on the second telescopic section, preferably on a rear wall of the second telescopic section, and which projects at least in certain regions into the third telescopic section, wherein the at least one deflection roller is arranged on the at least one fastening device.

By arranging the at least one fastening device on the second telescopic section, a movement coupling of the at least one synchronizing device with the second telescopic section can be achieved, wherein the third telescopic section is preferably moved with the second telescopic section via a movement coupling with the at least one synchronizing device and/or telescopically extended synchronously.

In general, however, it is also conceivable to fasten the at least one fastening device to the third telescopic section, wherein the at least one fastening device is in certain regions moved out of the second telescopic section during the telescoping process.

In general, the third telescopic section can be telescoped along in the same amount as the second telescopic section, move out of the second telescopic section by the same amount as the second telescopic section is telescoped out of the first telescopic section (synchronous movement), and/or move out of the second telescopic section by a reduced or increased amount as the second telescopic section is telescoped out of the first telescopic section. The same applies to a telescopic retraction process.

Particularly preferably, a deflection roller, preferably closer to a front side of the second telescopic section, can be pretensioned by at least one chain tensioner that is preferably arranged on at least one fastening device that may be present.

This can reduce unwanted rope slack and/or improperly high chain tension.

In one embodiment of the invention, the at least one chain tensioner is designed in the form of a translationally extendable fastening device, a plug connection, and/or a thread arranged on the fastening device.

For example, the fastening device comprises a thread with which the fastening device is telescopable to increase chain tension. In general, however, a tensioning device which is separate from the fastening device or arranged on the fastening device can be provided which increases a tension of the at least one synchronizing device, for example by pressure. In this context, the term chain tensioner is to be interpreted so broadly that it can also be suitable for other synchronizing devices such as a belt or a rope.

According to a preferred embodiment of the invention, the at least one synchronizing device is arranged at a first fixing point on the third telescopic section, wherein preferably the first fixing point is designed as a bolt connection, magnetic connection, screw connection, and/or material connection of the at least one synchronizing device with the third telescopic section.

The first fixing point can generate a movement coupling with the third telescopic section when the second telescopic section moves. A magnetic connection, if present, can be switched inactive or active via a rear side of the second telescopic section or remotely.

It has proven advantageous that the first fixing point in a telescopically retracted operating position of the third telescopic section is arranged close to a rear side of the third telescopic section and/or in the area of a deflection roller, if present.

This can facilitate deactivation of the motion coupling and/or accessibility for maintenance of the at least one synchronizing device. However, it is also possible to arrange the first fixing point close to a front side of the third telescopic section.

Furthermore, the at least one synchronizing device is preferably arranged or arrangeable at a second fixing point with the first telescopic section, preferably detachably, via at least one fastening means.

The second fixing point can generate a movement coupling—in particular via the fastening device—with the second telescopic section for moving the third telescopic section along.

In another embodiment, the second fixing point is arranged in a telescopically retracted operating position of the third telescopic section of a front side of the third telescopic section close to, and/or in the region of, an optionally present deflection roller.

This can facilitate deactivation of the motion coupling and/or accessibility for maintenance of the at least one synchronizing device. However, it is also possible to arrange the second fixing point close to a rear side of the second telescopic section.

According to an advantageous embodiment of the invention, the at least one fastening means of the second fixing point is designed in the form of:
at least one bolt connection which can be released and/or connected manually, preferably from a front side of the third telescopic section and/or mechanically, preferably hydraulically, and/or
at least one magnetic connection which can be released and/or activated manually, preferably from a front side of the third telescopic section, or electromagnetically.

A bolt connection—which can generally also be used for the first fixing point—represents a structurally simple kinematic connection with the at least one synchronizing device.

A magnetic connection—which can generally also be used for the first fixing point—represents a connection with the at least one synchronizing device that can be easily deactivated and, for example, be used remotely when the fixing point is difficult to access.

Preferably, the two fixing points in the telescopically retracted operating position are spaced apart from one another, preferably substantially by a longitudinal extension of the at least one fastening device and/or by a spacing of the two deflection rollers, to be able to generate a high telescoping stroke—in particular over substantially a longitudinal extension of the third telescopic section without free space for optional telescopic section extensions.

According to an advantageous embodiment of the invention, the first telescopic section comprises at least one holding element arranged on the first telescopic section, preferably a rear wall of the first telescopic section, which holding element projects into the second telescopic section and at least in a telescopically retracted operating position of the third telescopic section into the third telescopic section, wherein the at least one fastening means is arranged on the at least one holding element, wherein preferably the at least one holding element is designed in the form of a profile or profile tube, particularly preferably a U-profile. The holding element can cause a movement coupling of the third telescopic section with the first telescopic section via the at least one synchronizing device, wherein preferably the third and first telescopic sections are connected to the at least one synchronizing device via the two fixing points.

Advantageously, the at least one fastening device and/or the at least one holding element is designed such that the at least one synchronizing device can be supported on the at least one fastening device and/or the at least one holding element in the event of a sagging of the at least one synchronizing device. For example, the at least one holding element can represent a chain trough for guiding the at least one synchronizing device.

It has proven advantageous that the at least one drive device and/or at least one additional drive device, if present, is designed as a hydraulic cylinder unit, electric drive unit, and/or cable drive unit, wherein preferably the at least one drive unit is arranged on an outer side of the second telescopic section.

Particularly preferably, the at least one synchronizing device comprises a translation device with which a telescoping speed of the third telescopic section can be slowed down and/or accelerated compared to a telescoping speed of the second telescopic section. This allows setting any telescoping speed of the third telescopic section.

According to a preferred embodiment of the invention, a free space for connecting at least one telescopic section extension remains between a front side of the third telescopic section and the at least one synchronizing device in a telescopically retracted operating position of the third telescopic section. For example, load-handling devices or crane arm extensions that can optionally be attached to the telescopic boom can be arranged in the free space.

In another embodiment of the invention, at least one fastening means (fastener) is provided for coupling the movement of the second telescopic section with that of the third telescopic section, wherein the at least one fastening means moves the third telescopic section together with the second telescopic section during a relative movement of the second telescopic section with respect to the first telescopic section. This results in a kinematic coupling of the three telescopic sections of the telescopic boom.

In a preferred embodiment of the invention, at least one, preferably driven, chain wheel is arranged on the at least one synchronizing device.

At least one transmission device for the asynchronous movement of the third telescopic section or telescopic boom can be implemented particularly conveniently by means of a chain wheel. Furthermore, in the case of a drive unit—for example an electric or hydraulic one—in direct connection with the at least one chain wheel, a drive unit, in particular a hydraulic one, arranged on the outside of the telescopic section can be eliminated.

For example, a positive connection to the at least one synchronizing device can be provided via the at least one chain wheel and/or an alternative drive device or a supplementary drive device for the at least one synchronizing device, which is preferably designed as an integrated drive. Particularly preferably, a sensor system—such as a rotary encoder—can be connected to the at least one chain wheel for determining and/or further processing measurement data.

With a drive for the synchronizing device, preferably arranged directly on the synchronizing device and/or an axis of the chain wheel and/or electrically and/or within the second telescopic boom, it is possible for the innermost/third telescopic boom to be telescoped relative to the second telescopic boom without an indirect movement coupling between the outer/first telescopic boom relative to the second telescopic boom. This allows a relative movement of the innermost telescopic section without requiring an external drive (e.g. hydraulic drive). Decoupling from the first telescopic section can be achieved, for example, by releasing the fixing point in connection with the first telescopic section.

The synchronizing device can act to convey the rotational movement of the axis, preferably via a drive arranged directly on the axis, particularly preferably of the at least one chain wheel, into a translational movement of the third telescopic section. An additional drive via the first telescopic section is not required to telescopically extend the innermost telescopic section out of the second telescopic section.

It is particularly preferred that the working device has at least one fastening point separate from the first telescopic section, at which at least one holding element is arranged.

Preferably, the at least one synchronizing device is decoupled from the second telescopic section, preferably via at least one fastening means, and the second telescopic section is optionally movement-coupled to the third telescopic section, preferably by at least one fastening means, such that during a translational movement of the second telescopic section, the third telescopic section is moved together with the second telescopic section relative to the first telescopic section.

By decoupling the at least one synchronizing device, a relative telescopic movement between the second telescopic section and the third telescopic section can be deactivated, such that the second telescopic section and the third telescopic section is telescopable together to the same extent relative to the first telescopic section.

### BRIEF DESCRIPTION OF THE DRAWINGS

The features of the device claims are applicable to the method claims and vice versa. Further details and advantages of the present invention are explained in more detail below with reference to the drawings, in which:

FIG. 1 is a sectional view from a side of telescopic boom according to a particularly preferred embodiment,

FIGS. 2a, 2b are a side view and a perspective view of a telescopic boom with three telescopic sections in a telescopically retracted operating position,

FIGS. 3a, 3b are a side view and a perspective view of the telescopic boom according to the embodiment of FIG. 2a in a partially telescopically extended state,

FIGS. 4a, 4b are a side view and a perspective view of the telescopic boom according to the embodiment of FIG. 2a in the telescopically extended operating position,

FIG. 5 is sectional view from the side of a telescopic boom according to another preferred embodiment with chain wheels.

### DETAILED DESCRIPTION OF THE INVENTION

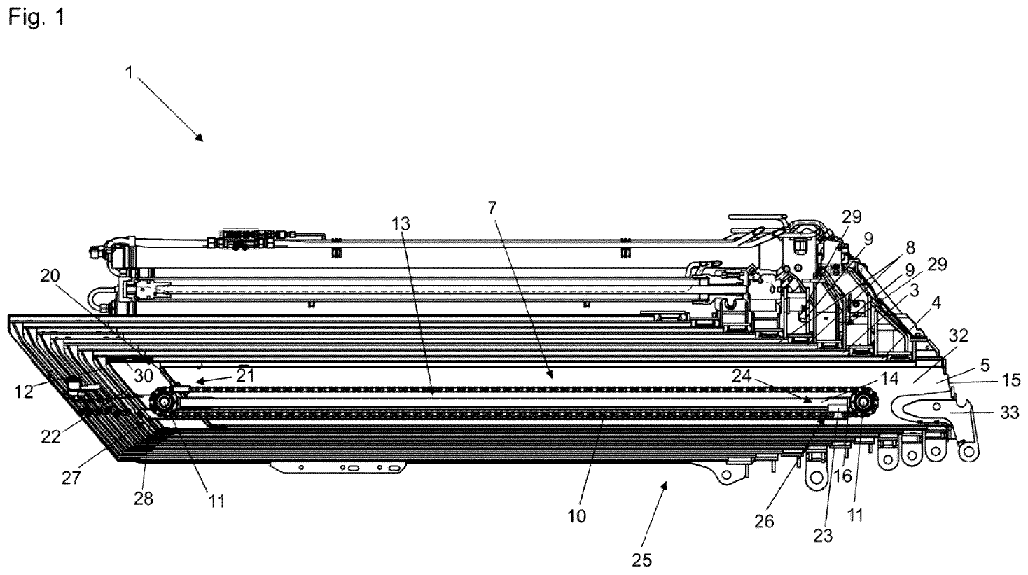

FIG. 1 shows a telescopic boom 1 for a working device in the form of a crane or a mobile crane, comprising three telescopic sections 3, 4, 5, wherein a first telescopic section 3 is arranged around a second telescopic section 4 and the second telescopic section 4 is arranged around a third telescopic section 5, at least one drive device 6 for telescopically retracting and/or extending the second telescopic section 4 relative to the first telescopic section 3 and at least one synchronizing device 7 by means of which the third telescopic section 5 is telescopable synchronously relative to the second telescopic section 4.

In general, the synchronizing device 7 can comprise a translation device 31 with which a telescoping speed of the third telescoping section 5 can be slowed down or accelerated compared to a telescoping speed of the second telescoping section 4, such that the telescoping movement takes place asynchronously despite the identical telescoping direction. However, this is not mandatory.

The first telescopic section 3 is telescopic relative to other telescopic sections 8 via another drive device 9, wherein the first telescopic section 3 could also represent a non-telescopable telescopic section (if the working device has only three telescopic sections, for example).

In the telescopic boom 1, the synchronizing device 7 is arranged entirely within the second telescopic section 4.

In the telescopic boom 1, the synchronizing device 7 is arranged in the illustrated telescopally retracted operating position 25 completely within the first telescopic section 3 and partially within the third telescopic section 5. In general, a complete arrangement within the third telescopic section 5 in the telescoped operating position 25 is also conceivable. In partially telescopically extended operating positions, the synchronizing device 7 is arranged in certain regions within the third telescopic section 5 and is in certain regions extended from the first telescopic section 3 during the telescoping movement. In the fully telescopically extended operating position, the synchronizing device 7 can also be arranged completely outside the first telescopic section 3 or the third telescopic section 5.

The telescopic boom 1 is provided with additional telescopic sections 8, which are arranged around the three telescopic sections 3, 4, 5 and can be maneuvered by additional drive devices 9.

The drive device 6 and the other drive devices 9 are designed as hydraulic cylinder units 29, individual or all drive devices 6, 9 can also be designed as an electric drive unit or as a cable drive unit. The drive unit 6 is arranged on an outer side 30 of the second telescopic section 4.

The synchronizing device 7 comprises a chain 10. A plurality of synchronizing devices 7 can also be included in the telescopic boom 1. Alternatively or additionally, the synchronizing device 7 can be designed as a belt or a rope. The chain 10 as such is elastically deformable by means of chain links.

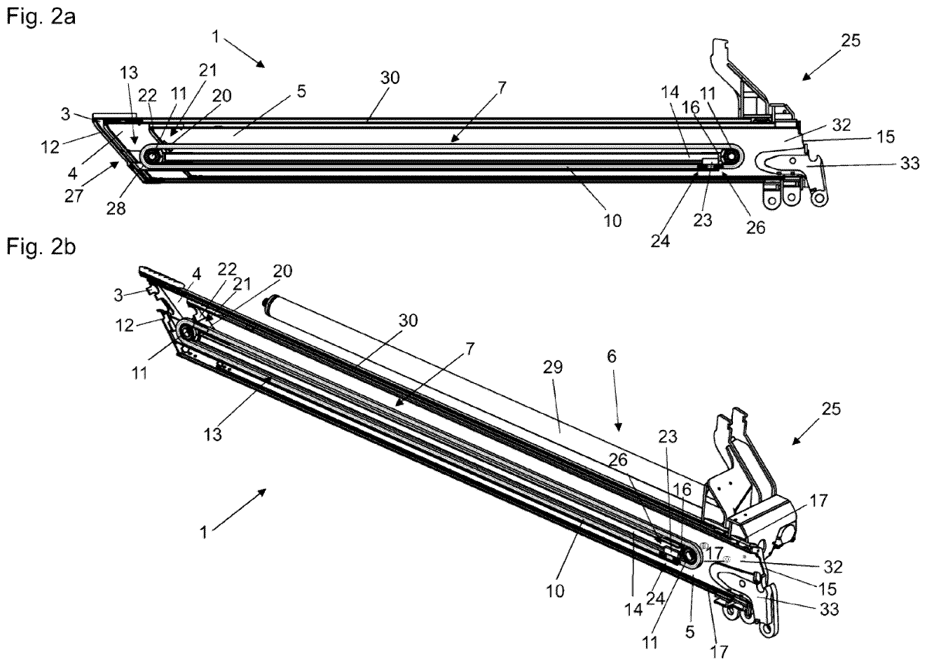

A telescoping process of the telescopic boom 1 is explained with reference to FIGS. 2a to 4b, wherein a method for telescopically retracting or extending the telescopic boom can be explained as follows: The second telescopic section 4 is moved translationally relative to the first telescopic section 3 via the hydraulic or electric drive device 6 and, in parallel, the third telescopic section 5 is moved translationally synchronously relative to the second telescopic section 4 by a movement of the second telescopic section 4 via the synchronizing device 7.

Optionally, the synchronizing device 7 can be decoupled from the second telescopic section 4 via the fastening means 24 and the second telescopic section 4 can be movement-coupled to the third telescopic section 5 by a fastening means 24, such that during a translational movement of the second telescopic section 4, the third telescopic section 5 is moved together with the second telescopic section 4 relative to the first telescopic section 3.

FIG. 2a shows that the synchronizing device 7 comprises two deflection rollers 11, wherein the chain 10 is guided around both deflection rollers 11 and is connected to itself. The two deflection rollers 11 are spaced apart from each other on the telescopic boom 1.

In FIG. 2b it can be seen that in the telescopically retracted operating position 25 of the third telescopic section 5, a free space 32 remains between a front side 15 of the third telescopic section 5 and the synchronizing device 7 for connecting a telescopic section extension 33. The telescopic section extension 33 shown is in the form of a load-carrying device, whereby alternatively or in addition other telescopic section extensions 33 (such as an articulated arm system) can be connected to the telescopic boom 1.

A fastening means 24 for coupling the movement of the second telescopic section 4 with the third telescopic section 5 is provided, wherein the fastening means 24 causes the third telescopic section 5 to move together with the second telescopic section 4 during a relative movement of the second telescopic section 4 with respect to the first telescopic section 3.

The synchronizing device 7 is arranged at a first fixing point 20 on the third telescopic section 5, wherein the first fixing point 20 is designed as a bolt connection 21. Alternatively or in addition, the first fixing point can also be designed as a screw connection, a material connection of the synchronizing device 7 with the third telescopic section 5, or as a magnetic connection.

In the telescopically retracted operating position 25 of the third telescopic section 5, the first fixing point 20 is arranged close to a rear side 22 of the third telescopic section 5 and in the region of one of the two deflection rollers 11.

The synchronizing device 7 is arranged at a second fixing point 23 with the first telescopic section 3 in a detachable manner via a fastening means 24, wherein a permanent connection is in general also possible.

In the telescopically retracted operating position 25 of the third telescopic section 5, the second fixing point 23 is arranged close to a front side 15 of the third telescopic section 5 and in the region of one of the two deflection rollers 11.

The synchronizing device 7 is connected to the first telescopic section 3 via the holding element 27, to the second telescopic section 4 via the fastening device 13, and to the third telescopic section 5 via the first fixing point 20.

The fastening means 24 of the second fixing point 23 is designed as a magnetic connection 26, which can be released and activated manually—from a front side 15 of the third telescopic section 5 or a rear wall 12 of the second telescopic section 4—or electromagnetically. The fastening means 24 can generally also be formed by a bolt connection 21 or a screw connection, which can be released and connected manually from a front side 15 of the third telescopic section 5 and mechanically—for example, hydraulically. In general, a cohesive connection of the second fixing point 23 is also conceivable, wherein inactivation of the simultaneous movement of the third telescopic section 5 with the second telescopic section 4 can always be provided or can be carried out via another deactivation option—for example provided at the first fixing point 20.

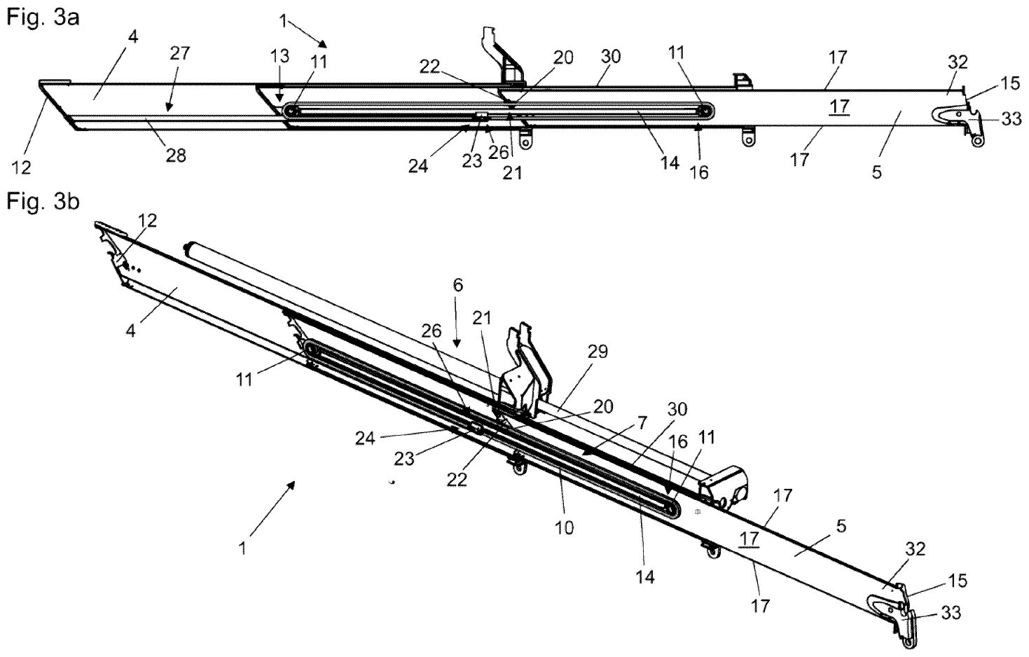

FIG. 3a shows a partially telescoped operating position of the second telescopic section 4 relative to the first telescopic section via the drive device 6 (not shown for reasons of clarity-see FIG. 2b), whereby the third telescopic section 5 has automatically telescoped out to the same extent (synchronously) relative to the second telescopic section 4 via the synchronizing device 7 (since no translation is provided in this embodiment).

FIG. 3b differs from FIG. 3a by a changed viewing angle. It can be seen that the second telescopic section 4 comprises a fastening device 13 in the form of a profile tube 14 arranged on the second telescopic section 4—the rear wall 12 of the second telescopic section 4. In this operating position, the profile tube 14 extends in certain regions into the third telescopic section 5 and the first telescopic section 3, wherein the two deflection rollers 11 are arranged on the fastening device 13—for example, welded to the side.

The deflection roller 11 closer to the front side 15 of the second telescopic section 4 can be pre-tensioned by means of a chain tensioner 16 arranged on the fastening device 13. In general, the chain tensioner 16 can also be spaced apart from the fastening device 13 on the telescopic boom 1.

The chain tensioner 16 is in the form of a translationally extendable fastening device 13 as a thread arranged on the fastening device 13. Alternatively or additionally, the chain 10 can also be tightened via a plug connection.

Both in the retracted and extended positions of the telescopic boom 1, the synchronizing device 7 is arranged entirely within planes which are spanned by all side surfaces 10 of the third telescopic section 5.

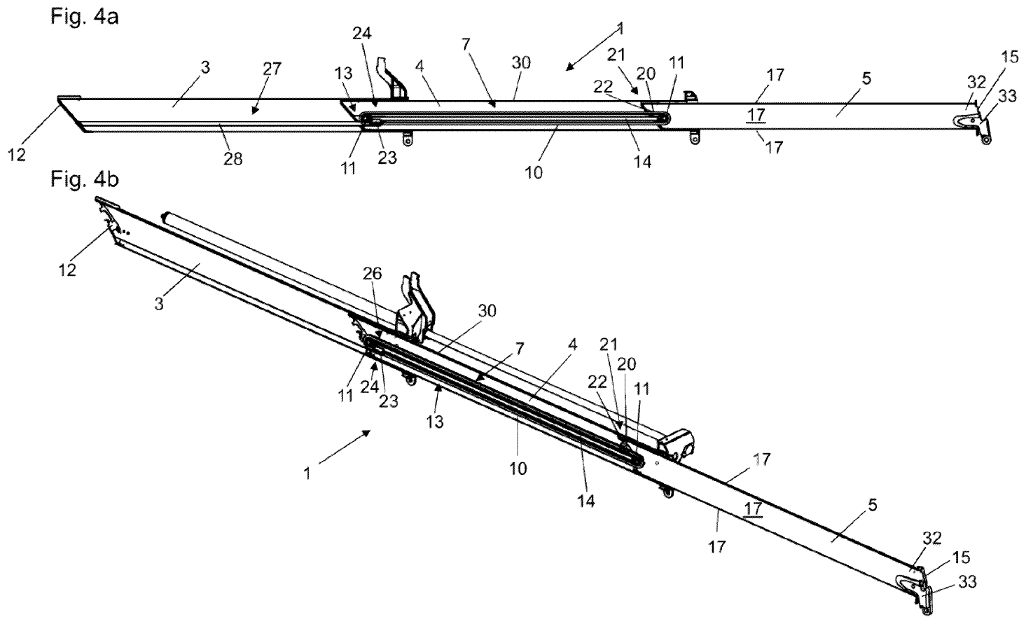

FIG. 4a shows the telescopic boom 1 in the fully telescopically extended operating position. The working device on which the telescopic boom 1 is arranged can generally also have a fastening point separate from the first telescopic section 3, on which a holding element 27 is arranged. The telescopic boom 1 can generally also have a fastening point for the fastening device 13 that is separate from the second telescopic section 4.

The first telescopic section 3 in this embodiment comprises the holding element 27 arranged on the rear wall 12 of the first telescopic section 3, which projects into the second telescopic section 4 and, in the telescopically retracted operating position 25 of the third telescopic section 5, into the third telescopic section 5. The fastening means 24 is arranged on the holding element 27, wherein the holding element 27 is designed in the form of a U-profile 28.

In FIG. 4b, the telescopic boom 1 can be seen in a different viewing direction compared to FIG. 4a. The fastening device 13 and the holding element 27 are designed such that the synchronizing device 7 can be supported by gravity on the fastening device 13 and by gravity on the holding element 27 in the event of sagging of the synchronizing device 7. However, this is not necessary if the synchronizing device 7 is sufficiently pre-tensioned via the chain tensioner 16.

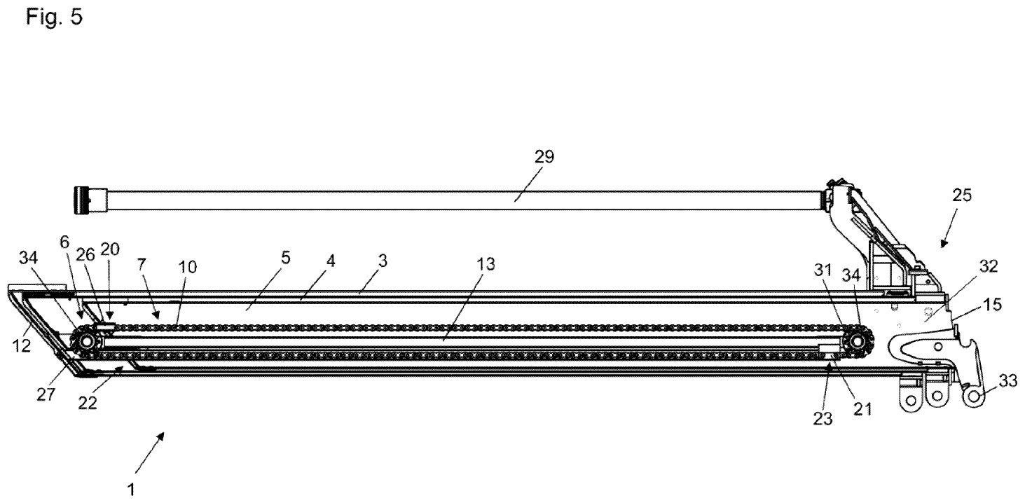

FIG. 5 shows an embodiment of a telescopic boom 1 in which two chain wheels 34 are provided instead of the deflection rollers 11, wherein the two chain wheels 34 are arranged on the synchronizing device 7. At least one chain wheel 34 is driven electrically or hydraulically (not shown in the representation for reasons of clarity) via a drive unit arranged within the second telescopic section 4 (this is generally not absolutely necessary) to be able to eliminate a hydraulic cylinder unit 29 arranged on the outside of the telescopic boom 1 or to use it as a supplement.

In general, the synchronizing device 7 in connection with the chain wheels 34 can comprise a translation device 31 with which a telescoping speed of the third telescoping section 5 can be slowed down or accelerated compared to a telescoping speed of the second telescoping section 4, such that the telescoping movement takes place asynchronously despite the identical telescoping direction.

In this telescopic boom 1, the first fixing point 20 is designed as a detachable magnetic connection 26 and the second fixing point 23 is designed as a bolt connection 21, wherein both fixing points 20, 23 can in general also be designed as a magnetic connection 26.

The other design features in connection with the deflection roller 11—for example, the chain tensioner 16—are also applicable in the embodiment with the chain wheel 34. A combination of deflection roller 11 and chain wheel 34 is also possible.

Even without the first telescopic section 3 or when the first telescopic section 3 is decoupled, a relative movement of the third telescopic section 5 is possible via the drive of the synchronizing device 7.

1. A telescopic boom for a working device, in particular a crane or mobile crane, comprising:
at least three telescopic sections, wherein a first telescopic section is arranged, at least in certain regions, around a second telescopic section and the second telescopic section is arranged at least in certain regions around a third telescopic section,
at least one drive device for telescopically retracting and/or extending the second telescopic section relative to the first telescopic section, and
at least one synchronizing device by means of which the third telescopic section is telescopable relative to the second telescopic section, in particular synchronously,
wherein the at least one synchronizing device is arranged substantially completely within the second telescopic section.

2. The telescopic boom according to claim 1, wherein the first telescopic section is designed to be telescopable or non-telescopable relative to at least one other telescopic section via at least one other drive device.

3. The telescopic boom according to claim 1, wherein the at least one synchronizing device is arranged at least in certain regions within the third telescopic section and completely within planes spanned by at least four, preferably all, side surfaces of the third telescopic section.

4. The telescopic boom according to claim 1, wherein the at least one synchronizing device is designed in the form of a chain, a belt, and/or a rope, wherein preferably the chain, the belt, and/or the rope is elastically deformable.

5. The telescopic boom according to claim 1, wherein the at least one synchronizing device comprises at least one deflection roller, wherein the at least one synchronizing device is guided around the at least one deflection roller and/or is connected to itself, wherein preferably at least two deflection rollers are provided that are spaced apart from one another.

6. The telescopic boom according to claim 5, wherein the second telescopic section comprises at least one fastening device, preferably a profile or profile tube, which is arranged directly or indirectly on the second telescopic section, preferably on a rear wall of the second telescopic section, which projects at least in certain regions into the third telescopic section, wherein the at least one deflection roller is arranged on the at least one fastening device.

7. The telescopic boom according to claim 5, wherein a deflection roller, preferably located closer to a front side of the second telescopic section, can be pretensioned by at least one chain tensioner, preferably arranged on at least one optionally present fastening device.

8. The telescopic boom according to claim 7, wherein the at least one chain tensioner is designed in the form of a translationally extendable fastening device, a plug connection, and/or a thread arranged on the fastening device.

9. The telescopic boom according to claim 1, wherein the at least one synchronizing device is arranged at a first fixing point on the third telescopic section, wherein it is preferably provided that the first fixing point is designed as a bolt connection, magnetic connection, screw connection, and/or cohesive connection of the at least one synchronizing device to the third telescopic section.

10. The telescopic boom according to claim 9, wherein the first fixing point, in a telescopically retracted operating position of the third telescopic section, is arranged close to a rear side of the third telescopic section and/or in the region of an optionally present deflection roller.

11. The telescopic boom according to claim 1, wherein the at least one synchronizing device is arranged or arrangeable at a second fixing point with the first telescopic section, preferably detachably, via at least one fastening means.

12. The telescopic boom according to claim 11, wherein, in a telescopically retracted operating position of the third telescopic section, the second fixing point is arranged close to a front side of the third telescopic section and/or in the region of one of the two deflection rollers.

13. The telescopic boom according to claim 11, wherein the at least one fastening means of the second fixing point is configured as:
at least one bolt connection to be released and/or connected manually, preferably from a front side of the third telescopic section and/or mechanically, preferably hydraulically, and/or
at least one magnetic connection which can be released and/or activated manually, preferably from a front side of the third telescopic section, or electromagnetically.

14. The telescopic boom according to claim 11, wherein the first telescopic section comprises at least one holding element arranged on the first telescopic section, preferably a rear wall of the first telescopic section, which projects into the second telescopic section and at least in a telescopically retracted operating position of the third telescopic section into the third telescopic section, wherein the at least one fastening means is arranged on the at least one holding element, wherein it is preferably provided that the at least one holding element is designed in the form of a profile or profile tube, particularly preferably a U-profile.

15. The telescopic boom according to claim 6, wherein the at least one fastening device and/or the at least one holding element is designed such that the at least one synchronizing device can be supported on the at least one fastening device and/or the at least one holding element in the event of a sagging of the at least one synchronizing device.

16. The telescopic boom according to claim 1, wherein the at least one drive device and/or at least one optionally present other drive device is designed as a hydraulic cylinder unit, electric drive unit, and/or cable drive unit, wherein preferably the at least one drive unit is arranged on an outer side of the second telescopic section.

17. The telescopic boom according to claim 1, wherein the at least one synchronizing device comprises a translation device with which a telescoping speed of the third telescopic section can be slowed down and/or accelerated compared to a telescoping speed of the second telescoping section.

18. The telescopic boom according to claim 1, wherein, in a telescopically retracted operating position of the third telescopic section, a free space for connecting at least one telescopic section extension remains between a front side of the third telescopic section and the at least one synchronizing device.

19. The telescopic boom according to claim 1, wherein a fastening means for coupling the movement of the second telescopic section with the third telescopic section is provided, wherein the at least one fastening means causes the third telescopic section to move together with the second telescopic section during a relative movement of the second telescopic section with respect to the first telescopic section.

20. The telescopic boom according to claim 1, wherein at least one, preferably driven, chain wheel is arranged on the at least one synchronizing device.

21. A working device, in particular a crane or mobile crane, with at least one telescopic boom according to claim 1, wherein in particular at least one other telescopic section is provided which is arranged, at least in certain regions, around the at least three telescopic sections.

22. The working device according to claim 21, wherein the working device has at least one fastening point separate from the first telescopic section, at which at least one holding element is arranged.

23. A method for telescopically retracting or extending a telescopic boom according to claim 1, comprising the following method steps, which are in particular to be carried out in parallel:
the second telescopic section is moved translationally relative to the first telescopic section via the, in particular hydraulic, drive device, and
the third telescopic section is moved translationally relative to the second telescopic section by a movement of the second telescopic section via the at least one synchronizing device, preferably synchronously.

24. The method according to claim 23, wherein the at least one synchronizing device is decoupled from the second telescopic section, preferably via at least one fastening means, and the second telescopic section is optionally movement-coupled to the third telescopic section, preferably by at least one fastening means, such that during a translational movement of the second telescopic section, the third telescopic section is moved together with the second telescopic section relative to the first telescopic section.
